(19) United States
(12) Patent Application Publication
(10) Pub. No.: US 2020/0331646 A1
(43) Pub. Date: Oct. 22, 2020

(54) ORGANIC MEAT PACKAGING

(71) Applicant: Sun Beef, LLC, Woodland, CA (US)

(72) Inventor: Robert Van Dorn, Danville, CA (US)

(21) Appl. No.: 16/387,005

(22) Filed: Apr. 17, 2019

(51) Int. Cl. B65B 25/06; A23B 4/16; B65D 81/26; A23B 4/20

(52) U.S. Cl. CPC B65B 25/067; A23B 4/16; B65D 81/2076; A23B 4/20; B65D 81/266

(57) ABSTRACT

The present disclosure describes methods and systems for packaging meat products, which may be organic, in low-oxygen preservation bags configured to extend the shelf-life of the meat. Packaging methods may involve placing a plurality of pre-proportioned organic meat products on a substrate and wrapping a film around the meat and substrate. The wrapped meat products may then be positioned in a bag containing ambient air. The ambient air may be purged from the bag using a first vacuum cycle, which may be followed by a second vacuum cycle. The method can also involve flushing the bag with a gas mixture after and/or between the vacuum cycles. The gas mixture may be comprised of nitrogen and/or carbon dioxide, but not carbon monoxide. The vacuumed, gas-flushed bags may then be sealed.

### TECHNICAL FIELD

Implementations relate to meat packaging systems and associated methods. Particular implementations include systems equipped to package organic meat in low-oxygen preservation bags configured to extend the shelf-life of the meat.

### BACKGROUND

Many techniques are employed to package and preserve meat products, such as ground beef. Such techniques often apply an assortment of preservative chemicals and/or gases to the meat products. Additional approaches may involve packaging the meat products using materials impermeable to air, thereby reducing exposure to oxygen and bacteria. Such approaches may be acceptable for non-organic meat products, but are not acceptable for organic products. This is because organic products can only be exposed to a limited variety of solely organic-certified materials. As a result, organic meat products may have considerably shorter shelf lives than comparable non-organic meat products. New methods of packaging organic meat products in a manner that is compliant with organic certification standards but also extends the shelf life of the packaged products are thus needed.

### BRIEF DESCRIPTION OF THE DRAWINGS

FIG. 1 is a diagram of a meat packaging system implemented in accordance with principles of the present disclosure.

FIG. 2 is a flow diagram of a method of meat packaging performed in accordance with principles of the present disclosure.

### SUMMARY

In accordance with principles of the present disclosure, a method of packaging organic meat may involve placing each of a plurality of pre-proportioned organic meat products on a substrate configured to receive the meat, wrapping a film around each of the meat products and its respective substrate, and positioning a plurality of the wrapped meat products in a bag, where in an initial state, the bag contains ambient air. The method may further involve purging the ambient air from the bag using a first vacuum cycle, purging any remaining air from the bag using a second vacuum cycle, and flushing the bag with a gas mixture, which may include a blend of nitrogen and carbon dioxide but not carbon monoxide. After flushing, the bag containing the gas mixture may be sealed.

In some examples, the film may be perforated. In some embodiments, the substrate may be a polyethylene tray. In some examples, an absorber pad may be arranged between the polyethylene tray and the organic meat. In some embodiments, the organic meat may comprise ground beef. Example methods may further involve positioning an oxygen absorber in the bag prior to sealing.

In some embodiments, the steps of purging may involve using controlled vacuum packaging. In some examples, the gas mixture may include about 30 to about 40% carbon dioxide and about 60 to about 80% nitrogen. In some embodiments, the method may further involve applying a perforated label to the film. In some examples, the method may also involve grinding the organic meat in one or more grinding steps to form ground organic meat. In some embodiments, the method may further involve extruding the ground organic meat. In some examples, the method may also involve flushing the bag with the gas mixture after the first vacuum cycle but before the second vacuum cycle.

In accordance with principles of the present disclosure, a meat packaging system may include a plurality of substrates each configured to receive a pre-proportioned organic meat product, and a bag configured to receive a plurality of the wrapped meat products, where in an initial state, the bag contains ambient air. The system can further include a vacuum configured to purge the ambient air from the bag using a first vacuum cycle and a second vacuum cycle, a gas tank configured to flush the bag with a gas mixture, where the gas mixture includes a blend of nitrogen and carbon dioxide and where the gas mixture is free of carbon monoxide, and a sealing apparatus configured to seal the bag containing the gas mixture.

In some examples, the film may be perforated. In some embodiments, the substrate may be a polyethylene tray. In some examples, the organic meat may comprise ground beef. In some embodiments, the system may also include an oxygen absorber positioned in the bag. In some examples, the gas mixture may include about 30 to about 40% carbon dioxide and about 60 to about 80% nitrogen. In some embodiments, the system may also include a coarse grinding apparatus and a fine grinding apparatus, each apparatus configured to grind the organic meat. In some examples, the system may further include an extruder configured to form the organic meat into a noodle consistency.

### DETAILED DESCRIPTION

Implementations provide packaging systems and associated methods applicable to certified organic meat products, which may include meat derived from animals raised in living conditions accommodating their natural behaviors, fed organic feed and forage, and not administered antibiotics or hormones. Implementations are not limited to organic meat products, only, and may be applicable to additional meat products, such as non-organic, natural meat products. Embodiments can generally involve placing loaves of ground meat into plastic trays, wrapping the trays with film, and adding two or more trays to a preservation bag. After evacuating oxygen, a combination of carbon dioxide and nitrogen is pumped into the preservation bag before sealing. Disclosed methods may employ polyethylene trays, instead of traditionally used foam trays, which can facilitate oxygen removal from the preservation bags. Embodiments may also implement a unique double-cycle evacuation of oxygen from each preservation bag along with the addition of a novel gas blend specifically lacking carbon monoxide, which together may reduce the oxygen level within the bags to extremely low levels. The carbon-monoxide-free gas blend, which can include a combination of carbon dioxide and nitrogen, can extend the shelf life of the meat and preserve its natural color, all while maintaining the meat's certified organic status. The shelf life of the meat within the unopened preservation bags may be around 18 days, and at least another 2 days after unsealing the bags.

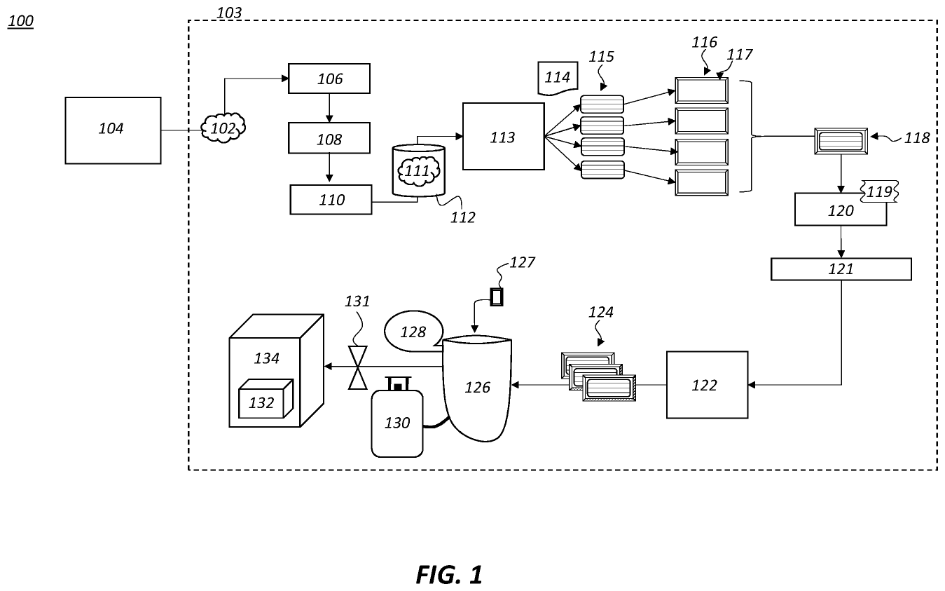

FIG. 1 shows an example meat packaging system 100 arranged in accordance with principles of the present disclosure. As shown, the base or starting meat 102, e.g., raw, unseasoned or otherwise fresh, organic meat, can be received at a packaging facility 103 from an initial production facility 104, which can be a USDA production facility, meat storage facility, and/or farm. Within the packaging facility 103, which may also be USDA certified, the meat 102 can be input to a coarse grinding apparatus 106, and then input into a blender 108 and a fine grinding apparatus 110. The ground meat 111 can be optionally placed into one or more bins 112 and transferred to an extruder 113, where the meat 111 may be further ground and extruded in a continuous, noodled composition sliced into defined portions by a portioning apparatus 114, thereby forming separate loaves 115. Each of the loaves 115 can be placed into respective packaging trays 116. The resulting meat trays 118 can be wrapped in film 119, for example using a wrapping apparatus 120, and passed through a metal detection apparatus 121. Meat trays 118 containing no metal can then be labeled at a labeling apparatus 122, and the labeled meat trays 124 packaged together in a preservation bag 126. A vacuum apparatus 128 coupled to the preservation bag 126 can remove oxygen from the preservation bag 126, and one or more gas tanks 130 can pump a gas blend into the preservation bag 126, thereby flushing additional oxygen from the bag. After sealing the preservation bag 126 containing the labeled meat trays 124, one or more preservation bags 126 can be collected in insulated cases 132 and stored in a refrigerator or cooler 134 until shipping. The resulting shelf life of the meat within the unopened preservation bags 126 may be longer than other organic meat products not packaged via the system 100. For example, the shelf-life of the meat within the unopened preservation bags 126 may be around 18 days. After unsealing the preservation bags, the shelf life may be at least about 2 days.

The starting meat 102 may be organic. Various types and cuts of organic meat are within the scope of this disclosure. For example, organic beef, chicken, pork and/or turkey can each be processed by the system 100 shown in FIG. 1. In specific embodiments, grass-fed, organic ground beef may be processed and packaged. The starting meat 102 can include fresh meat, frozen meat, or a blend of fresh and frozen meat. In some embodiments, the starting meat 102 may be less than 1, 2, 3, 4, 5, 6, 7, 8, 9 or 10 days old, calculated from the time the meat is harvested. The starting meat 102 can have variable pH levels, for example ranging from about 5 to about 6, about 5.2 to about 5.8, about 5.4 to about 5.6, about 5.4 to about 5.7, or any range therebetween. The ratio of lean meat to fat in the starting meat 102 may also vary, for example ranging from 70:30, 80:20, 90:10, 95:5, 98:2, or any ratio therebetween. The methods described herein are not limited to any particular ratio.

The packaging facility 103 can include apparatuses configured to process and package the starting meat 102, as well as apparatuses, e.g., conveyer belts, configured to facilitate transfer of the meat between two or more separate pieces of equipment. The conditions of the packaging facility 103 may vary. For example, the production floor temperature may range from about 32° F. to about 40° F., about 34° F. to about 39° F., about 34° F. to about 36° F., or any temperature therebetween.

The coarse grinding apparatus 106 can be configured to receive the starting meat 102 and grind it into about a ⅝ in. grind. The grind settings may vary, and can be adjustable. For example, the grind size may range from about ⅜ in. to about 1 in., about ½ in. to about ⅞ in., or about ⅝ in. to about ¾ in., or any grind size therebetween. The blending apparatus 108 can be configured to mix the ground meat, which may homogenize the meat and improve its consistency. The fine grinding apparatus 110 can be configured to receive the meat from the blending apparatus 108 and grind it into a more refined grind size, e.g., about ⅛ in. The grind settings may again vary, and can be adjustable. For example, the grind size may range from about 1/12 in. to about ⅜ in., about 1/10 in. to about 2/8 in., about ⅛ in. to about ⅙ in., or any grind size therebetween. In some implementations, the coarse grinding apparatus 106, blending apparatus 108 and/or the fine grinding apparatus 110 may be connected, such that the starting meat 102 can be smoothly and quickly transferred from one apparatus to the next with little to no manual engagement. The fully ground meat 111 may exit the fine grinding apparatus 110 at a temperature of about 30° F. in some examples, or at a temperature ranging from about 26° F. to about 38° F., or any temperature therebetween. In some examples, one or more steps of grinding and/or blending may be excluded, for example such that the starting meat 102 passes through the coarse grinding apparatus 106, the blender 108 and/or the fine grinding apparatus 110. The ground meat 111 can optionally be placed into containers or bins 112 after grinding/blending, which may be made of stainless steel in various embodiments.

After grinding and/or blending, the ground meat 111 can be added to an extruder 113. The extruder 113 can be configured to receive the ground meat 111 from the fine grinding apparatus 110, e.g., via a hopper or attachment configured to funnel the ground meat 111 therein. The configuration and settings of the extruder 113 may vary. In specific embodiments, a VEMAG® extruder 113 may be utilized. The extruder 113 can be configured to further grind the ground meat 111, for example using a ⅛ in. grinding device. The extruder 113 may also apply elevated pressure, temperature and/or moisture to the ground meat 111 as the meat is churned and/or urged therethrough. The extruder 113 can ultimately force the ground meat 111 through a die, which can include openings or holes shaped to form the meat into a noodle-like shape. The nascent meat can be sliced or otherwise portioned by the portioning apparatus 114 as it exits the extruder 113, thereby forming separate blocks or loaves 115 of meat. Depending on user preference, the settings of the portioning apparatus 114 may be adjusted such that each loaf 115 may range from about 0.25 lbs. to about 2.0 lbs. or more, about 0.5 lbs. to about 1.5 lbs., about 0.75 lbs. to about 1.25 lbs., about 1 lb. or any weight therebetween. The shape and dimensions of each loaf 115 may vary, and in some examples, may generally comprise an approximately rectangular shape. At one or more stages, a scale may be used to confirm the weight of each loaf 115.

The loaves 115 can be placed into trays 116 to begin packaging. Unlike preexisting meat packaging systems, which may utilize foam trays, e.g., polystyrene foam, the trays 116 utilized according to the present disclosure may comprise one or more generally hard or rigid polymers or polymer blends. In some examples, the trays 116 may be formed partially or entirely of polyethylene (PET). The trays 116 can also be BPA free. Because foam trays comprise about 90% air, the use of trays 116 comprised of PET or comparable polymers, which include significantly less trapped air, may improve the effectiveness of evacuating oxygen from the preservation bag, for example to levels at or below 0.8% oxygen. Each of the trays 116 can include an absorber pad 117 positioned between the tray and the loaves, the absorber pad 117 configured to soak up any excess purge and/or blood from the meat loaves 115. The dimensions of each tray 116 may vary. In embodiments, the width of each tray 116 may be less than about 4 in. or about 4, 4.5, 5, 5.5, 6, 6.5, 7, 7.5, 8, 8.5, 9, 9.5, or 10 in. or greater. The length of each tray 116 may be less than about 6 in. or about 6, 6.5, 7, 7.5, 8, 8.5, 9, 9.5, 10, 10.5, 11, 11.5, 12, or 12.5 in. or greater. The depth of each tray 116 may also vary, ranging from less than about 0.25 in. or about 0.25, 0.5, 0.75, 1.0, 1.25 or 1.5 in. or greater. The absorber pads 117 are generally smaller than the surface area within each tray 116, having a width of less than about 3 in. or about 3, 3.5, 4, 4.5, 5, 5.5, 6, or about 6.5 in. or greater, and a length of less than about 5 in. or about 5, 5.5, 6, 6.5, 7, 7.5, 8, 8.5, or 9 in. or greater.

After placing the loaves 115 into the trays 116, the meat trays 118 can be wrapped in a film 119, which may be perforated and/or may comprise a non-barrier (permeable) film, by a wrapping apparatus 120, which may be configured to stretch and/or flow wrap the meat trays 118. Perforated and/or non-barrier films may be uniquely suited for the methods disclosed herein due to the manner in which oxygen is purged from the preservation bags containing the film-wrapped meat trays. For example, specific embodiments can utilize perforated strength wrap, which can comprise a clear plastic wrap configured to allow oxygen to escape the loaves 115, which may cause the meat to turn purple in color. Once the preservation bags 126 (see further below) are opened, the perforation of the film 119 can allow oxygen back into the meat, creating oxymyoglobin, which may cause the meat to turn back to a red or pink color. The film 119 can be configured to cling directly to the meat trays 118.

The meat trays 118 can then be passed through the metal detection apparatus 121 configured to detect any fragments of metal embedded within the loaves 115. Meat trays 118 containing metal-contaminated loaves can be removed from the assembly line, while metal-free loaves can continue to the labeling apparatus 122. The labeling apparatus 122 can include a printer, e.g., ink jet printer, configured to apply one or more labels to the meat trays 118, for example using an adhesive stick-on printed label. In embodiments, the labeling apparatus 122 can place a label on the top and/or bottom of each meat tray 118. A lot code may be applied on the front or top of each tray, i.e., on the film covering each loaf. The packaging date and/or product specifications, for example, may also be labeled. In some examples, at least one label applied via the labeling apparatus 122 can be perforated, such that the label exhibits oxygen permeability properties similar to the perforated film 119 used to wrap the meat trays 118. Embodiments may also involve bypassing the labeling apparatus 122.

The labeled meat trays 124 can then be inserted into preservation bags 126, which may comprise one or more polymers or polymer blends. The number of meat trays 124 added to each preservation bag 126 can vary, ranging from about 1, 2, 3, 4, 5, 6, 7, 8, 9, 10 or more labeled meat trays 124 per bag 126. In specific embodiments, each preservation bag 126 may accommodate 3 meat trays 124. The dimensions and thus capacity of each preservation bag 126 may also vary for instance depending on how many meat trays 124 are to be included. For example, each preservation bag 126 may have a width of about 10 in., or a width ranging from about 6, 7, 8, 9, 10, 11, 12, 13, 14, or 15 in. or greater. The length of each preservation bag 126 may be about 34 in., or may range in embodiments from about 24, 26, 28, 30, 32, 34, 36, 38, 40, 42, or 44 in. or greater. The cross-sectional thickness of the preservation bag 126 may vary, ranging from about 2 mm to about 6 mm, about 3 mm to about 5 mm, or about 4 mm.

Each preservation bag 126 may also include an oxygen absorber 127 placed therein. The oxygen absorber 127 may comprise a chemical composition enclosed in a packet or pouch, the chemical composition configured to remove oxygen molecules from the surrounding environment, i.e., the environment within each preservation bag 126. Example oxygen absorbers 127 can include variously sized OXYFREE® absorbers. Oxygen absorbers 127 of various sizes were tested to determine the optimal size for the particular applications disclosed herein. This assessment revealed that the oxygen absorber 127 positioned within each preservation bag 126 may have a higher capacity than recommended according to user instructions. For example, each oxygen absorber 127 may have a capacity of about 30 gr to about 68 gr, about 44 gr to about 64 gr, about 48 gr to about 60 gr, about 52 gr to about 56 gr, or about 54 gr. In some embodiments, a 54 gram oxygen absorber 127 can be used to maximize oxygen removal with minimal excess oxygen removal capacity remaining.

The oxygen present within each preservation bag 126 may be evacuated or purged using a vacuum apparatus 128 coupled thereto, for example via a tube inserted into the preservation bag 126 or attached to a valve on the preservation bag 126. In particular examples, the vacuum apparatus 128 may comprise a CVP® modified atmosphere packaging machine. The vacuum apparatus 128 may be configured to perform controlled vacuum packaging to purge the oxygen via 2 vacuum cycles, implemented in succession with a gas flush cycle in between and/or afterward. For example, the vacuum apparatus 128 may purge the ambient air present within the preservation bag 126 using a first vacuum cycle, which also collapses the bag around the meat trays 124. After the first vacuum cycle, a gas mixture derived from one or more gas tanks 130 can be used to flush each preservation bag 126, thereby further reducing the oxygen content therein. Any remaining ambient air and added gas may then be purged from the preservation bag 126 via a second vacuum cycle, which may be followed by another input of the gas mixture to flush any remaining oxygen before sealing each bag. Despite the additional processing time required to perform 2 cycles of oxygen evacuation, which initially deterred the inventors of the present application from adding a second evacuation cycle, a dual-cycle approach may be preferred. In particular, dual-cycle oxygen evacuation implemented via interspersed vacuuming and gas flushing may be critical, in at least some examples, to remove an amount of oxygen from the bags sufficient to extend the shelf life of the meat placed therein. Considerable experimentation revealed that implementing only a single oxygen evacuation cycle may not sufficiently lower the oxygen content of the preservation bags 126, thereby reducing the shelf life of the meat contained therein. Similarly, implementing only a vacuum step or a gas-flushing step, but not both, may be insufficient for improving shelf life, even if vacuuming or gas flushing steps are performed repeatedly. In some approaches, more than 2 vacuum cycles may be implemented in succession to ensure ambient air is purged, such as 3, 4 or 5 vacuum cycles. Each vacuum cycle may last for about 10 to about 20 seconds, which may maximize oxygen removal without over-extending the processing time required to do so.

The composition of the gas mixture may vary. For example, the gas mixture can comprise nitrogen and carbon dioxide contained in one or more gas tanks 130. The ratio of nitrogen to carbon dioxide included in the gas mixture may vary. For example, the gas mixture may comprise about 70% nitrogen and about 30% carbon dioxide. Additional embodiments can include nitrogen levels ranging from less than about 55%, or about 55%, 65%, 75%, 85%, 95% or more, or any level therebetween. Carbon dioxide levels can range from less than about 5%, or about 5%, 15%, 25%, 35%, 45% or more, or any level therebetween. In some examples, the gas mixture may be comprised of 100% nitrogen. Various embodiments may also be free of nitrogen, carbon dioxide, and/or oxygen. The gas mixture may be contained in a single gas tank, or the carbon dioxide and nitrogen may be contained in separate tanks, each tank reversibly coupled to each preservation bag filled according to the system 100. The gas mixture may be certified organic, such that the nitrogen may be oil-free grade. The gas mixture may exclude carbon monoxide, which in preexisting meat packaging systems has typically been considered critical to both preserving the natural color of meat and sufficiently reducing the oxygen content of the meat packages. Despite omitting carbon monoxide from the gas mixtures applied herein, the disclosed methods have been found to effectively reduce the oxygen content within each preservation bag 126 to less than about 3%, 2%, 1%, or lower, for example about 0.8%, which may extend the shelf life of the meat within the preservation bags 126. The amount of the gas mixture pumped into each preservation bag 126 may vary. Generally, the gas mixture can be pumped into a bag until the bag is approximately crescent-shaped or semicircular and/or standing about 4 in. to about 5 in. higher than before gas injection.

The low-oxygen, gas-filled preservation bags 126 containing the meat trays 124 can be sealed, for example via a sealing apparatus 131, and then be placed into insulated cases 132 such that each case contains, for example, about 3 preservation bags 126. The number of preservation bags 126 included in each case 132 may vary and may depend on the dimensions of each case 132. For example, each case 132 may have a width of about 10 in., or a width ranging from about 6, 7, 8, 9, 10, 11, 12, 13, 14, or 15 in. or greater. The length of each case 132 may be about 34 in., or may range in embodiments from about 24, 26, 28, 30, 32, 34, 36, 38, 40, 42, or 44 in. or greater. Each case 132 may have a depth of about 16 in., or a depth ranging from about 3, 8, 10, 12, 14, 16, 18, 20, 22, 24, or 26 in. or greater. The cases 132 can be stored in the cooler 134 until shipped, for example for up to about 12 days. The temperature within the cooler 134 may vary, ranging from about 32° F. to about 40° F., about 32° F. to about 36° F., or about 32° F. to about 34° F., or any temperature therebetween.

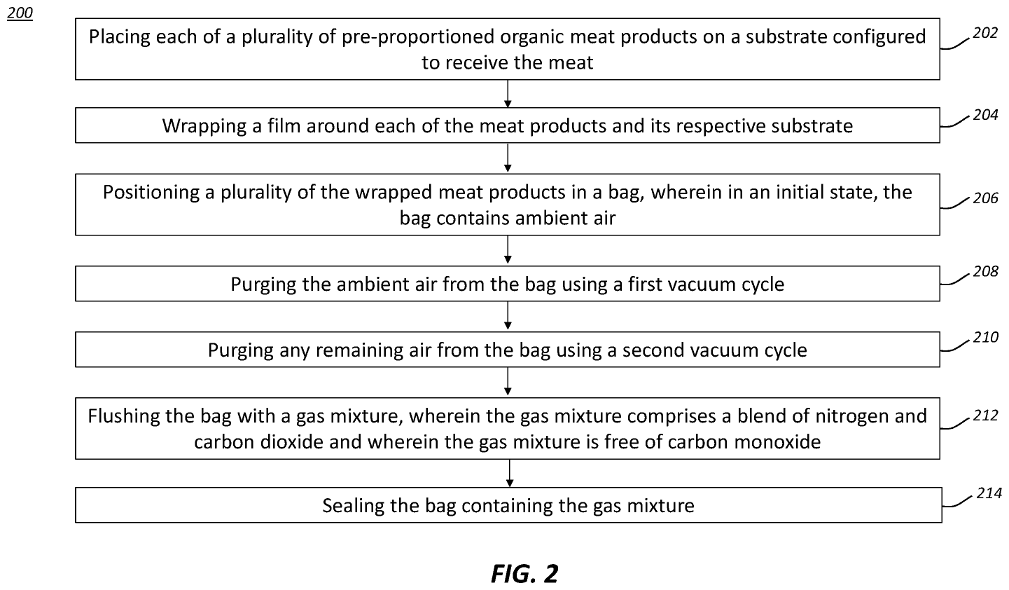

FIG. 2 is a flowchart of an example method 200 of preserving meat products implemented in accordance with the present disclosure. The example method 200 shows the steps that may be implemented, in any sequence, to package meat products in a manner that extends shelf life without sacrificing the organic status of the meat products. In additional examples, one or more of the steps shown in the method 200 may be supplemented or omitted.

In the embodiment shown, the method 200 begins at block 202 by “placing each of a plurality of pre-proportioned organic meat products on a substrate configured to receive the meat.”

At block 204, the method further involves “wrapping a film around each of the meat products and its respective substrate.”

At block 206, the method involves “positioning a plurality of the wrapped meat products in a bag, wherein in an initial state, the bag contains ambient air.”

At block 208, the method involves “purging the ambient air from the bag using a first vacuum cycle.”

At block 210, the method involves “purging any remaining air from the bag using a second vacuum cycle.”

At block 212, the method further involves “flushing the bag with a gas mixture, wherein the gas mixture comprises a blend of nitrogen and carbon dioxide and wherein the gas mixture is free of carbon monoxide.”

At block 214, the method involves “sealing the bag containing the gas mixture.”

As used herein, the term “about” modifying, for example, the quantity of a component in a composition, concentration, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or components used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities.

Similarly, it should be appreciated that in the foregoing description of example embodiments, various features are sometimes grouped together in a single embodiment for the purpose of streamlining the disclosure and aiding in the understanding of one or more of the various aspects. These methods of disclosure, however, are not to be interpreted as reflecting an intention that the claims require more features than are expressly recited in each claim. Rather, as the following claims reflect, inventive aspects lie in less than all features of a single foregoing disclosed embodiment, and each embodiment described herein may contain more than one inventive feature.

Although the present disclosure provides references to preferred embodiments, persons skilled in the art will recognize that changes may be made in form and detail without departing from the spirit and scope of the invention.

What is claimed is:

1. A method of packaging organic meat, the method comprising:
placing each of a plurality of pre-proportioned organic meat products on a substrate configured to receive the meat;
wrapping a film around each of the meat products and its respective substrate;
positioning a plurality of the wrapped meat products in a bag, wherein in an initial state, the bag contains ambient air;
purging the ambient air from the bag using a first vacuum cycle;
purging any remaining air from the bag using a second vacuum cycle;
flushing the bag with a gas mixture, wherein the gas mixture comprises a blend of nitrogen and carbon dioxide and wherein the gas mixture is free of carbon monoxide; and
sealing the bag containing the gas mixture.

2. The method of claim 1, wherein the film is perforated.

3. The method of claim 1, wherein the substrate is a polyethylene tray.

4. The method of claim 3, further comprising an absorber pad arranged between the polyethylene tray and the organic meat.

5. The method of claim 1, wherein the organic meat is ground beef.

6. The method of claim 1, further comprising positioning an oxygen absorber in the bag prior to sealing.

7. The method of claim 1, wherein the steps of purging involve using controlled vacuum packaging.

8. The method of claim 1, where the gas mixture comprises about 30 to about 40% carbon dioxide and about 60 to about 80% nitrogen.

9. The method of claim 1, further comprising applying a perforated label to the film.

10. The method of claim 1, further comprising grinding the organic meat in one or more grinding steps to form ground organic meat.

11. The method of claim 10, further comprising extruding the ground organic meat.

12. The method of claim 1, further comprising flushing the bag with the gas mixture after the first vacuum cycle but before the second vacuum cycle.

13. A meat packaging system comprising:
a plurality of substrates each configured to receive a pre-proportioned organic meat product;
a wrapping apparatus configured to wrap a film around each of the meat products and its respective substrate;
a bag configured to receive a plurality of the wrapped meat products, wherein in an initial state, the bag contains ambient air;
a vacuum configured to purge the ambient air from the bag using a first vacuum cycle and a second vacuum cycle;
a gas tank configured to flush the bag with a gas mixture, wherein the gas mixture comprises a blend of nitrogen and carbon dioxide and wherein the gas mixture is free of carbon monoxide; and
a sealing apparatus configured to seal the bag containing the gas mixture.

14. The meat packaging system of claim 13, wherein the film is perforated.

15. The meat packaging system of claim 13, wherein the substrate is a polyethylene tray.

16. The meat packaging system of claim 13, wherein the organic meat is ground beef.

17. The meat packaging system of claim 13, further comprising an oxygen absorber positioned in the bag.

18. The meat packaging system of claim 13, where the gas mixture comprises about 30 to about 40% carbon dioxide and about 60 to about 80% nitrogen.

19. The meat packaging system of claim 13, further comprising a coarse grinding apparatus and a fine grinding apparatus, each apparatus configured to grind the organic meat.

20. The meat packaging system of claim 13, further comprising an extruder configured to form the organic meat into a noodle consistency.
